(19) United States
(12) Patent Application Publication
(10) Pub. No.: US 2026/0336100 A1
(43) Pub. Date: Oct. 29, 2026

(54) FORCE SENSING AND BIREFRINGENT IMAGING

(71) Applicant: Meta Platforms Technologies, LLC, Menlo Park, CA (US)

(72) Inventors: Salim Boutami, Seattle, WA (US); Onur Can Akkaya, Los Altos, CA (US); Khalid Omer, Seattle, WA (US); Yujie Wei, Redmond, WA (US); Reid Frederick Nichols Pinkham, Redmond, WA (US); Victoria Rose Most, Seattle, WA (US)

(21) Appl. No.: 19/650,653

(22) Filed: Apr. 17, 2026

Related U.S. Application Data
(60) Provisional application No. 63/797,013, filed on Apr. 29, 2025.

(51) Int. Cl. B25J 9/16; B25J 13/08; G01L 1/24; G01L 5/00; G06V 10/145; G06V 10/764

(52) U.S. Cl. CPC B25J 9/1612; B25J 13/085; G01L 1/24; G01L 5/0061; G06V 10/145; G06V 10/764

(57) ABSTRACT

A system includes a polarization camera, a deformable birefringent layer, and an illumination source. The deformable birefringent layer is configured to interact with objects. The illumination source is configured to emit polarized illumination light toward the deformable birefringent layer. The polarization camera is configured to selectively capture a force-image of returning light.

### CROSS-REFERENCE TO RELATED APPLICATIONS

This application claims priority to U.S. provisional Application No. 63/797,013 filed Apr. 29, 2025, which is hereby incorporated by reference.

### TECHNICAL FIELD

This disclosure relates generally to optics, and in particular to birefringent imaging.

### BACKGROUND INFORMATION

Birefringent imaging is an imaging technique the exploits the anisotropic nature of some materials that splits light into rays with different polarization orientations. The method has been used to identify minerals and for stress analysis in polymers and crystals, for example. In the semiconductor context, illuminating a crystalline semiconductor (e.g. silicon) with polarized light may reveal crystal defects in wafers.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a system that includes a hand of a robot, in accordance with aspects of the disclosure.

FIG. 2A illustrates a system that includes illumination sources, a polarization camera, and a deformable birefringent layer , in accordance with aspects of the disclosure.

FIG. 2B illustrates a system emitting polarized illumination light from a second illumination source when processing logic drives an illumination trigger signal onto a second light source, in accordance with aspects of the disclosure.

FIG. 2C illustrates that a first illumination source and a second illumination source may emit polarized illumination light with different elliptical polarization orientations, in accordance with aspects of the disclosure.

FIG. 2D illustrates an example system having a silicon fingertip, in accordance with aspects of the disclosure.

FIGS. 3A and 3B illustrate an example deformable birefringent layer that changes its refractive index in response to force, in accordance with aspects of the disclosure.

FIGS. 4A and 4B illustrate a shear-force image and a normal-force image of a deformable birefringence layer in a fingertip, in accordance with aspects of the disclosure.

FIGS. 4C and 4D illustrate a chart for determining the force magnitude from the force-images of the deformable birefringent layer, in accordance with aspects of the disclosure.

FIG. 5A illustrates an example polarized pixel arrangement that may be overlaid over portions of a polarization camera, in accordance with aspects of the disclosure.

FIG. 5B illustrates an example polarized pixel arrangement that may be overlaid over portions of a polarization camera, in accordance with aspects of the disclosure.

FIG. 5C illustrates an example polarized pixel arrangement that may be overlaid over portions of a polarization camera, in accordance with aspects of the disclosure.

FIGS. 6A and 6B illustrate the optical path for capturing target-image(s) of an object outside a fingertip, in accordance with aspects of the disclosure.

### DETAILED DESCRIPTION

Embodiments of force sensing and birefringent imaging are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In aspects of this disclosure, visible light may be defined as having a wavelength range of approximately 380 nm – 700 nm. Non-visible light may be defined as light having wavelengths that are outside the visible light range, such as ultraviolet light and infrared light. Infrared light having a wavelength range of approximately 700 nm – 1 mm includes near-infrared light. In aspects of this disclosure, near-infrared light may be defined as having a wavelength range of approximately 700 nm - 1.6 µm.

In aspects of this disclosure, the term “transparent” may be defined as having greater than 90% transmission of light. In some aspects, the term “transparent” may be defined as a material having greater than 90% transmission of visible light.

The field of robotics has witnessed significant advancements in recent years, driven by breakthroughs in artificial intelligence (AI), machine learning (ML), and the Internet of Things (IoT). Researchers have been exploring new frontiers in robotics, leading to the development of innovative applications, technologies, and methodologies.

Such developments include humanoid robots, which could perform versatile tasks, ideally similar to tasks performed by human beings. One of the important skills humans have is tactile sensing, which allow us to properly handle objects by applying the proper pressure to grab the object without damaging or dropping it. This may involve sensing some mechanical property of the object and/or discerning its surface texture/roughness.

A humanoid robot would ideally have similar tactile skills. Several technical options are possible for such robot fingers. Some of them fall into optical solutions domain. A camera for example, combined with an optical source, could be envisioned to measure the robot fingertip deformation, and also visualize and characterize the surface of the touched object. Performing both tasks (mechanical deformation and outside world visual observation) is a however a challenging task with conventional imaging.

In implementations of the disclosure, a robotic fingertip includes a polarization camera, a deformable birefringent layer (e.g. silicon), and an illumination source. The illumination source is configured to emit polarized illumination light toward the deformable birefringent layer and the polarization camera is configured to selectively capture a force-image of returning light that scatters/reflects from the deformable birefringent layer. As the robotic fingertip touches/contacts an object, the deformable birefringent layer is compressed and the polarization orientation of returning light changes. Thus, the force the robotic fingertip is asserting on the object can be measured by the force-image captured by the polarization camera. A normal force and/or a shear force may be measured by one or more force-images. An actuator that drives the robotic fingertip may be driven/adjusted based on the force image.

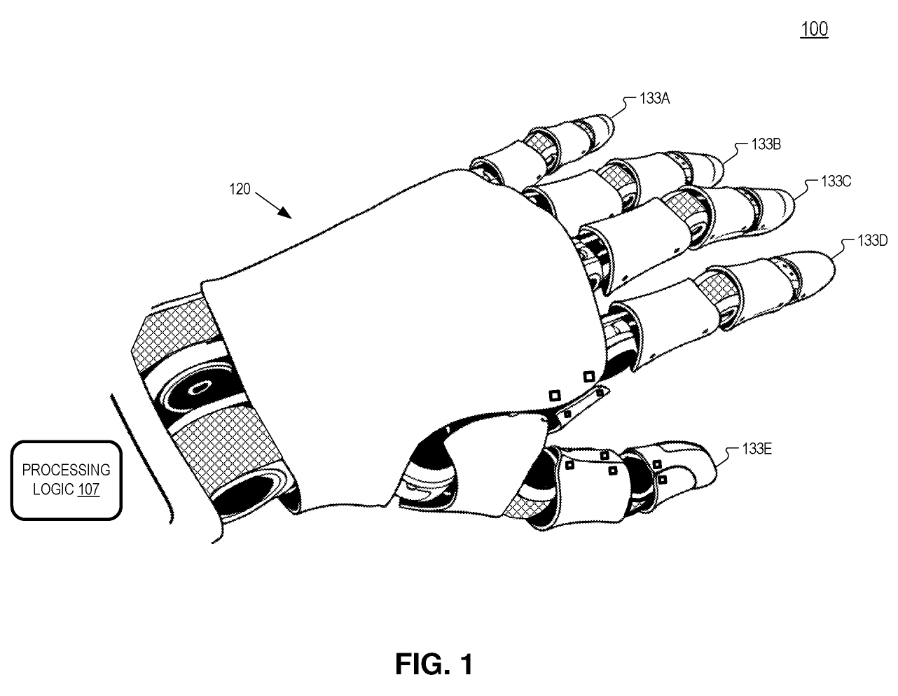

In addition to the polarization camera measuring force exerted by the robotic fingertip, the polarization camera may capture a target-image of an object outside the robotic fingertip by imaging through the deformable birefringent layer. Based on the target-image a surface roughness and/or a material type of the object may be classified based on analyzing the light intensity and the Degree of Linear Polarization (DOLP) of the target-image. Therefore, the actuator that mobilizes the robotic fingertip may be driven based on analyzing the force-image and the target-image. These and other implementations are discussed in more detail below in connection with FIGS. 1-6B.

FIG. 1 shows a system 100 that includes a hand 120 of a robot, in accordance with aspects of the disclosure. The robot may be considered a humanoid robot. Hand 120 includes fingertips 133A, 133B, 133C, 133D, and 133E (collectively referred to as fingertips 133). The system includes processing logic 107.

Actuators (not specifically referenced) may be included in the hand 120 of the robot to move the hand and/or individual fingertips 133. Electric servo motors may be used as actuators, in some implementations.

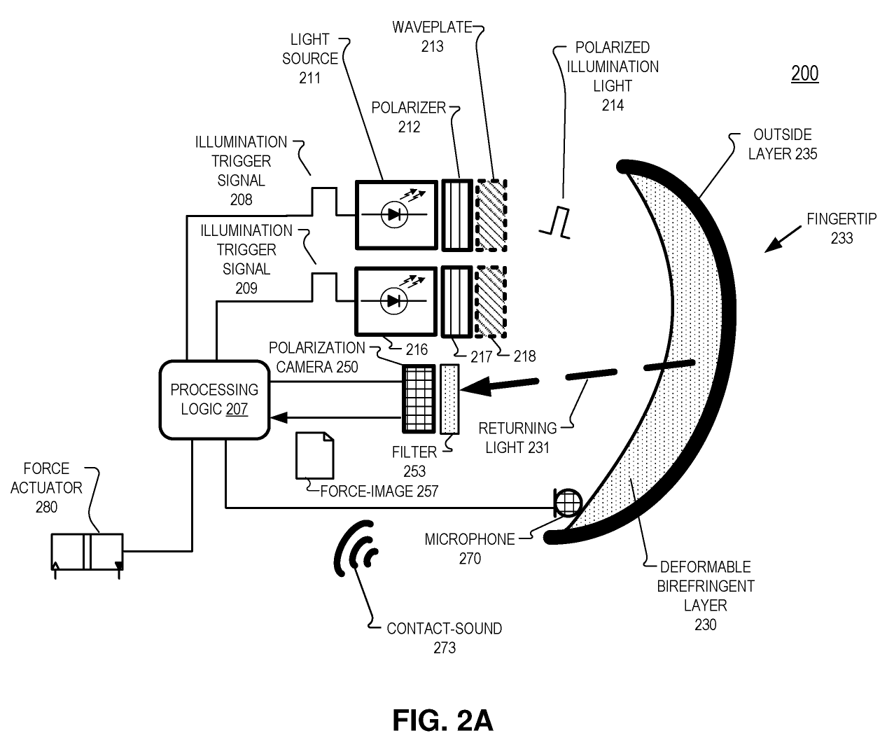

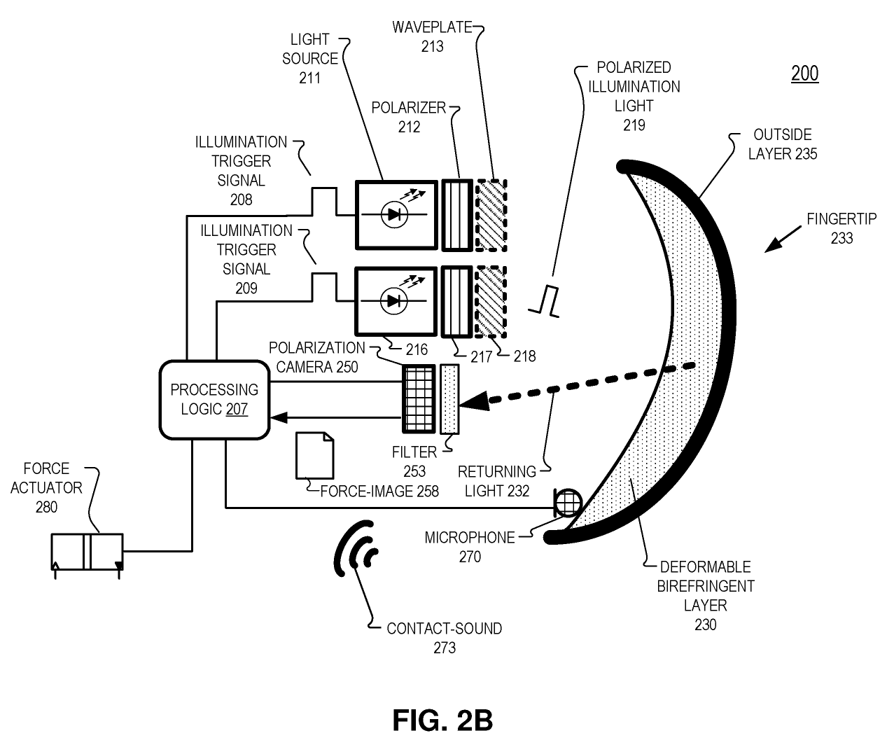

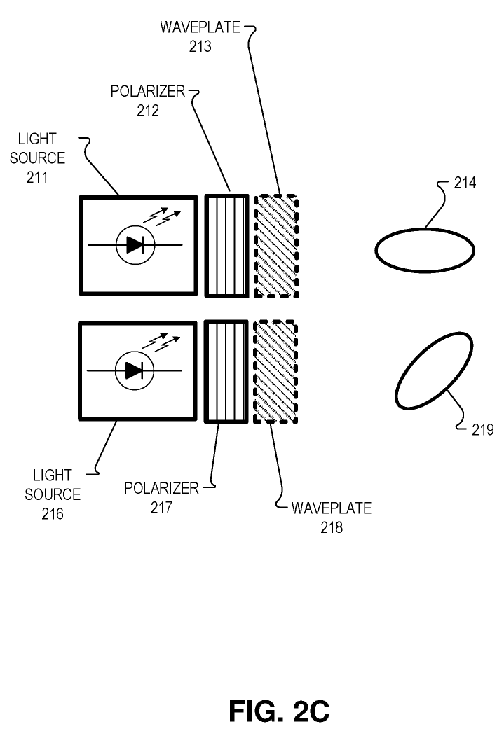

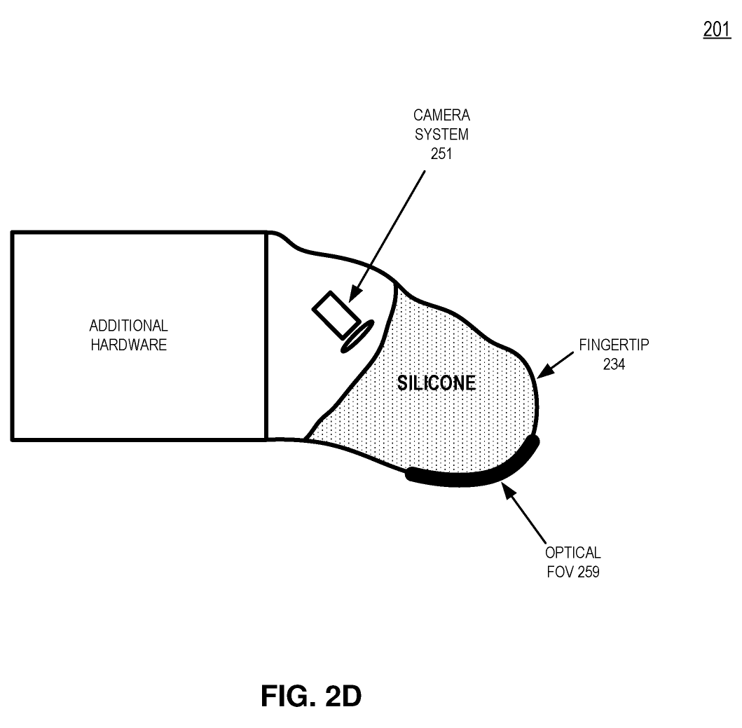

FIG. 2A illustrates a system 200 that includes illumination sources, a polarization camera, and a deformable birefringent layer, in accordance with aspects of the disclosure. System 200 includes processing logic 207 configured to output illumination trigger signals 208 and 209. These signals drive a pair of illumination sources. The first illumination source includes a light source 211, polarizer 212, and waveplate 213. The second illumination source includes a second light source 216, polarizer 217, and waveplate 218. Light source 211 and light source 216 may include one or more LEDs, lasers, or laser diodes, for example. The wavelength of the light sources 211 and 216 may be infrared light. In some implementations, the wavelength of light sources 211 and 216 is the same infrared wavelength. In some implementations, the wavelengths of light sources 211 and 216 is different.

In FIG. 2A, first light source 211 emits polarized illumination light 214 toward a fingertip 233 that includes a deformable birefringent layer 230. A polarizer 212 may polarize the light emitted by light source 211. Waveplate 213 is configured to shift the polarization axis of the incident light. In an example, incident linearly polarized light may be converted to circularly polarized light by waveplate 213. Likewise, incident circularly polarized light may be converted to linearly polarized light by waveplate 213. Waveplates may be made of birefringent materials such as quartz, organic material sheets, or liquid crystal, for example. In some implementations, waveplate 213 is configured as a 45 degree retarder. In some implementations, polarized illumination light 214 has an elliptical polarization orientation.

FIG. 2A also includes an optional second illumination source that includes second light source 216, polarizer 217, and waveplate 218. The second light source 216 is configured to emit polarized illumination light 219 toward fingertip 233. Polarizer 217 may polarize the light emitted by second light source 216. Waveplate 218 is configured to shift the polarization axis of the incident light. In some implementations, waveplate 218 is configured as a 90 degree retarder. In some implementations, polarized illumination light 219 has an elliptical polarization orientation.

As polarized illumination light 214 illuminates deformable birefringent layer 230, a portion of polarized illumination light 214 reflects or scatters back to polarization camera 250 as returning light 231. The deformable birefringent layer 230 may include silicon, in some implementations. The deformable birefringent layer 230 may be considered quasi-opaque so that light will scatter/reflect back to polarization camera 250 while also allowing some portion of the illumination light to propagate through the deformable birefringent layer 230. Returning light 231 has the same wavelength as polarized illumination light 214. When deformable birefringent layer 230 is compressed (and deformed) as it contacts an object in the environment of robot, the refractive index of deformable birefringent layer 230 increased in the direction of force. And when deformable birefringent layer 230 is illuminated by a polarized light source, the changes in the refractive index can be seen in force-images captured by polarization camera 250.

Returning light 231 passes through a filter 253 and is captured by a polarization camera 250, which generates a force-image 257 that may be provided to processing logic 207. A plurality of force-image(s) 257 may be captured as the fingertip 233 interacts with objects to assess the force asserted by fingertip 233. Processing logic 207 may drive illumination trigger signal 208 onto the light source 211 in order to coordinate the illumination light 214 illuminating deformable birefringent layer 230 while polarization camera 250 captures the force-image(s) 257 to determine the force asserted by fingertip 233.

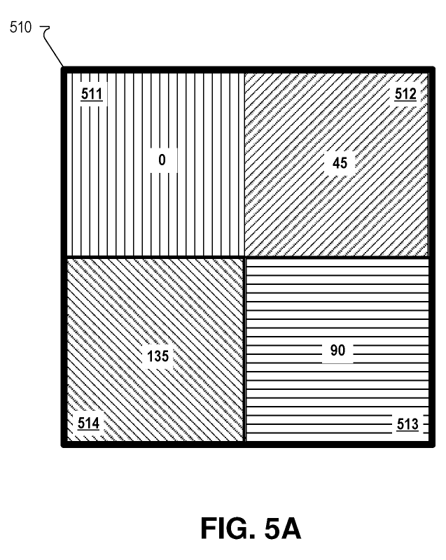

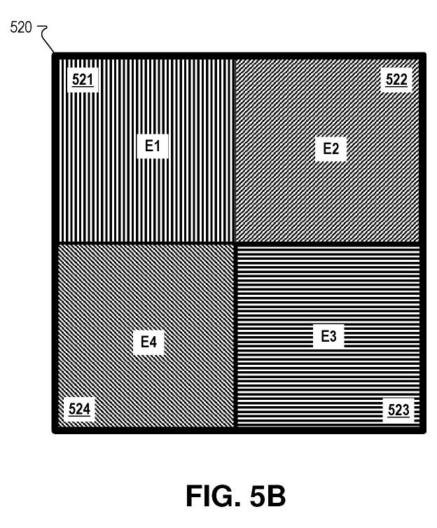

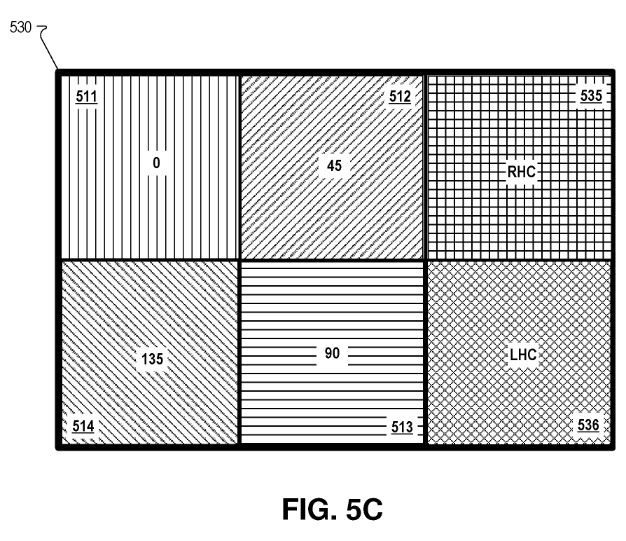

Polarization camera 250 may be configured to image at 30 frames per second (fps). Polarization camera 250 may be configured to image at 60 fps. Polarization camera 250 may be configured to image at 100 fps or greater. In an implementation, polarization camera 250 is configured to provide partial Stokes imaging. Polarization camera 250 may be configured to image four linear polarization states. In an implementation, polarization camera 250 is configured to provide full Stokes imaging. Polarization camera 250 may be configured to image four elliptical polarization states. Filter 253 may include a wavelength filter. The wavelength filter may be matched to pass the wavelength of light emitted by light sources 211 and 216. Filter 253 may include polarizers. Filter 253 may be implemented at the pixel level, as described in the description of FIGS. 5A-5C below.

System 200 illustrated in FIG. 2A optionally includes a microphone 270 that captures contact-sound 273 to send to the processing logic 207. Microphone 270 is included in the fingertip 233 and is configured to record contact-sound 273 of the robotic fingertip 233 interacting with an object outside the robotic fingertip. Microphone 270 is in contact with deformable birefringent layer 230, in some aspects. Processing logic 207 is configured to receive the contact-sound 273 from the microphone 270. Processing logic 207 may be configured to save a pre-touch image captured by polarization camera 250 immediately prior to the contact-sound 273 being recorded by microphone 270. This pre-contact image may be used as a baseline to compare force-image(s) 257 against the pre-contact image to analyze the change in polarization from the compression of deformable birefringent layer 230 and thereby determine the force asserted by fingertip 233. In some implementations, processing logic 207 is configured to generate a force-value by comparing the force-image 257 to the pre-touch image where the force-image 257 is captured subsequent to the contact-sound 273 being recorded by microphone 270.

FIG. 2A includes an actuator 280 to mobilize fingertip 233. Actuator 280 represents one or more actuators of the robot that may be actuated based on information provided from the fingertips. The one or more actuators may mobilize a single fingertip, multiple fingertips, the whole robotic hand, a robot arm connected to a robotic hand, or even the whole robot. The processing logic 207 is configured to drive the actuator 280 based on analyzing the force-image(s) 257 for force-patterns in the force-image(s). Force actuator 280 may be driven by processing logic 207 in response to analyzing the force-image(s).

Fingertip 233 may optionally include an outside layer 235. Outside layer 235 may be a partially mirrored surface. Outside layer 235 may be a metallic layer. Outside layer 235 may have a thickness between 5 nm and 50 nm. The partially mirrored surface of outside layer 235 may assist in reflecting a higher percentage of polarized illumination light 214 and/or polarized illumination light 219 back to polarization camera 250 to increase the signal to noise ratio for force-image 257. Yet outside layer 235 allows light from outside the fingertip 233 to propagate through outside layer 235 to become incident on polarization camera 250 so that the polarization camera can also image an object that is proximate to the fingertip 233. In some implementations, outside layer 235 is dichroic and reflects the wavelength (e.g. infrared) of the polarized illumination light 214 and/or polarized illumination light 219 while transmitting visible light.

FIG. 2B illustrates system 200 emitting polarized illumination light 219 from a second illumination source when processing logic 207 drives illumination trigger signal 209 onto a second light source 216, in accordance with aspects of the disclosure. System 200 optionally includes a second illumination source including second light source 216, polarizer 217, and waveplate 218. Polarized illumination light 219 may be emitted in a non-overlapping different time period to polarized illumination light 214. Polarized illumination light 219 may have a different polarization orientation than polarized illumination light 214.

As polarized illumination light 219 illuminates deformable birefringent layer 230, a portion of polarized illumination light 219 reflects or scatters back to polarization camera 250 as returning light 232. Returning light 232 has the same wavelength as polarized illumination light 219. This may allow polarization camera 250 to capture a second force-image 258 from the incident returning light 232. Since polarized illumination light 219 has a different polarization orientation than polarized illumination light 214, second force-image 258 may measure different polarization properties of the deformable birefringent layer 230 when it is compressed and uncompressed states.

The pre-contact image captured by polarization camera 250 may be used as a baseline to compare force-image(s) 258 against the pre-contact image to analyze the change in polarization from the compression of deformable birefringent layer 230 and thereby determine the force asserted by fingertip 233. In some implementations, processing logic 207 is configured to generate a force-value by comparing the force-image 258 to the pre-touch image where the force-image 258 is captured subsequent to the contact-sound 273 being recorded by microphone 270.

FIG. 2C illustrates that the first illumination source and the second illumination source may emit polarized illumination light with different elliptical polarization orientations, in accordance with aspects of the disclosure. For example, polarization illumination light 214 is illustrated as having a first elliptical state. In some implementations, the illustrated first elliptical state may be described as elliptically polarized light state whose polarization ellipse is aligned with the horizontal and vertical axes, with the major axis along the horizontal direction. To generate the first elliptical state, polarizer 212 may be a linear polarizer have an orientation of 0 degrees and waveplate 213 may be a 45 degree retarder. Polarization illumination light 219 is illustrated having a second elliptical state. In some implementations, the illustrated second elliptical state may be described as elliptically polarized state whose polarization ellipse is rotated 45 degrees with respect to the horizontal axis. To generate the second elliptical state, polarizer 217 may be a linear polarizer have an orientation of 45 degrees and waveplate 218 may be a 90 degree retarder.

FIG. 2D illustrates an example system 201 having a silicon fingertip 234, in accordance with aspects of the disclosure. FIG. 2D shows that fingertip 234 includes silicon as the deformable birefringent layer. Camera system 251 may include polarization camera 250, for example. Camera 251 is able to image objects outside the fingertip 234 through optical field of view (FOV) 259. Additional hardware (e.g. actuators and processing logic) may be located in the additional hardware section of the fingertip.

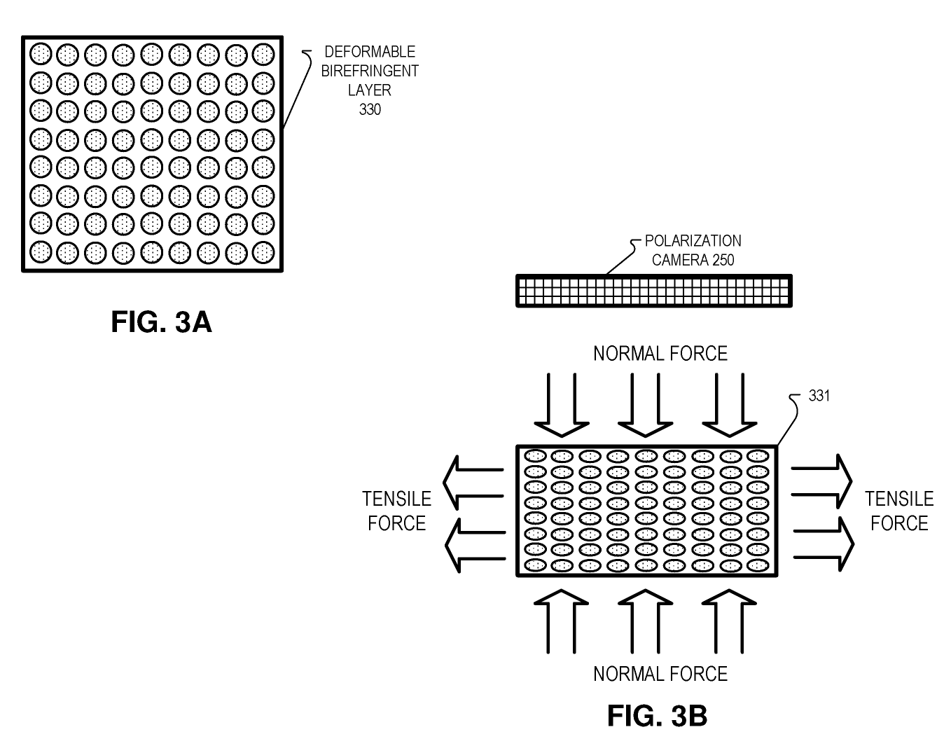

FIGS. 3A and 3B illustrate an example deformable birefringent layer 330 that changes its refractive index in response to force, in accordance with aspects of the disclosure. FIG. 3A illustrates an uncompressed deformable birefringent layer 330. FIG. 3B illustrates that forces on deformable birefringent layer 331 create birefringence observable by a polarization camera 250 when illuminated by a polarized source (not particularly illustrated in FIG. 3B). FIG. 3B shows that the refractive index is increased in the direction of force. The intensity of light transmitting through a compressed deformable birefringent layer 331 is less affected than the polarization orientation of the light propagating through. However, the polarization orientation of the light is affected by the increased refractive index from the compression as circularly polarized light will change from circular to linear, for example. For modeling purposes, the uncompressed deformable birefringent layer 330 may be considered isotropic whereas the normal force on the compressed deformable birefringent layer generates a uniaxial birefringence with the slow axis oriented along the direction of force and the retardance value (of compressed deformable birefringent layer 331) related to the magnitude of the normal force.

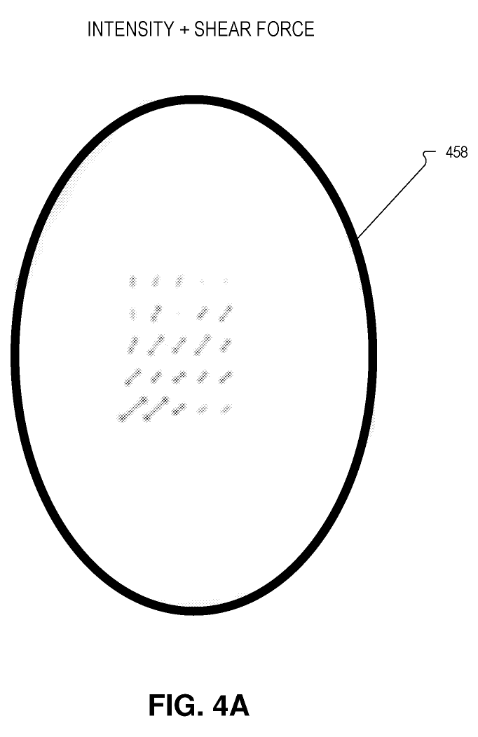

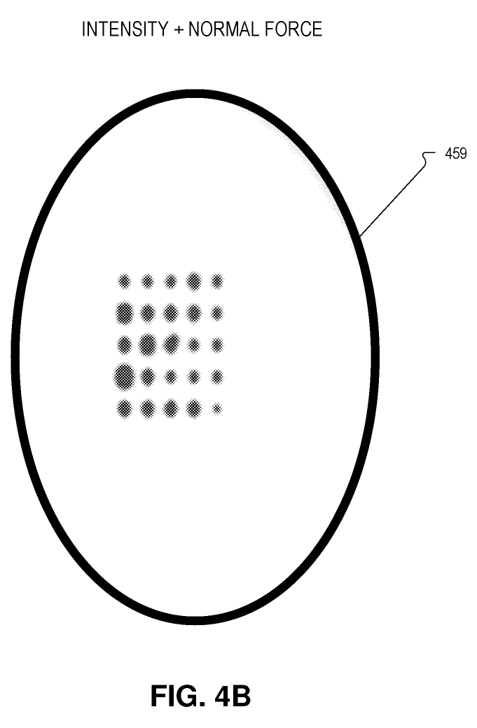

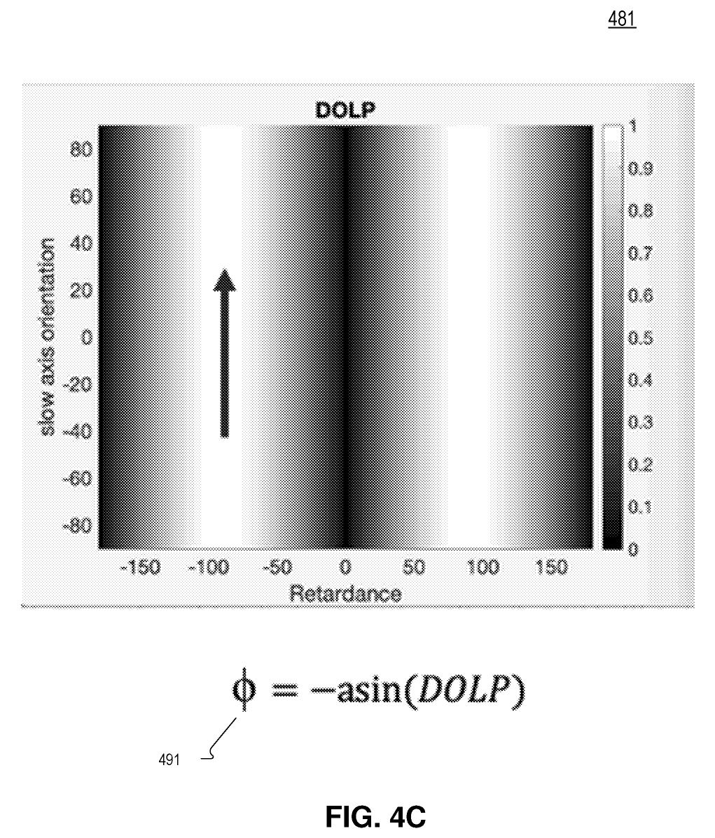

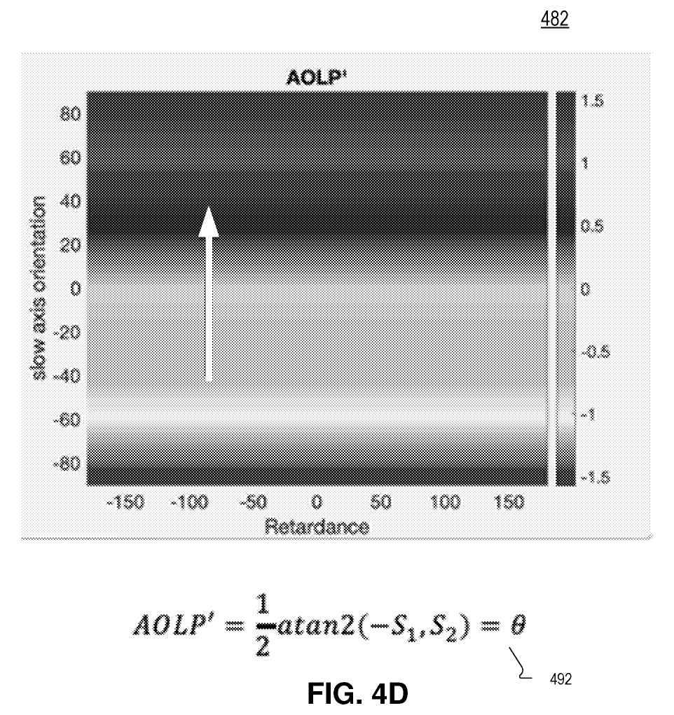

FIGS. 4A and 4B illustrate a shear-force image 458 and a normal-force image 459 of a deformable birefringence layer in a fingertip, in accordance with aspects of the disclosure. A shear force on the deformable birefringence layer in the fingertip creates: (1) a change in Degree of Linear Polarization (DOLP); and (2) a change in Angle of Linear Polarization if the force is not aligned with the long elliptical axis. The shear force may be defined as approximately orthogonal to an optical axis of the polarization camera 250. A normal force on the deformable birefringence layer in the fingertip creates: (1) a change in DOLP; and (2) no change in AOLP. The normal force direction may run approximately along an optical axis of the polarization camera. With only the first polarization illumination light 214 having a first elliptical state, if there is no AOLP change, it is unclear whether the force is a normal force or a shear force aligned with the ellipse long axis.

However, by time-multiplexing two elliptically polarized illumination sources that generate different elliptical states (e.g. light 214 and 219) having different long axis orientations, the ambiguity can be solved. More specifically, if both the first force-image 257 (captured by polarization camera 250 while layer 230 illuminated by illumination light 214) and the second force-image 258 (captured by polarization camera 250 while layer 230 is illuminated by illumination light 219) have no change in AOLP compared to a pre-touch image captured prior to contact with an object, the force is only a normal force. If at least one of the first force-image 257 and the second force-image 258 shows a change in AOLP, there is a shear component to the force.

FIGS. 4C and 4D illustrate a DOLP chart 481 for determining the force magnitude from the force-images of the deformable birefringent layer, in accordance with aspects of the disclosure. The force magnitude (ϕ) is given in equation 491. DOLP in equation 491 is given by DOLP = √(S₁ ²+S₂ ²)/S₀, where S₀, S₁, and S₂ are Stokes parameters determined from the images captured by polarization camera 250. The arrow in DOLP chart 481 represents the force path.

FIG. 4D illustrate an AOLP’ chart 482 for determining the force orientation from the force-images of the deformable birefringent layer, in accordance with aspects of the disclosure. The force orientation (θ) is given in equation 492. AOLP’ in equation 492 is given by AOLP’ = ½ atan2(-S₁, S₂) where S₁, and S₂ are Stokes parameters determined from the images captured by polarization camera 250. The arrow in AOLP’ chart 482 represents the force path. Using the techniques and calculations shown in FIGS. 4C and 4D, images 458 and 459 in FIGS. 4A and 4B are generated that show the shear force and the normal force across the fingertip.

In some implementations, machine learning techniques are utilized to reconstruct the shear force and/or normal force of the fingertip based on images from the polarization camera 250. Various known forces can be applied on the fingertip with corresponding polarization images captured by polarization camera 250. A neural network can then be trained to reconstruct the vectorial force field across the fingertip from the polarization images, for example.

FIG. 5A illustrates an example polarized pixel arrangement 510 that may be overlaid over portions of polarization camera 250, in accordance with aspects of the disclosure. Polarized pixel arrangement 510 includes four linear polarizers 511, 512, 513, and 514. Linear polarizer 511 has an orientation of zero degrees, linear polarizer 512 has an orientation of 45 degrees, linear polarizer 513 has an orientation of 90 degrees, and linear polarizer 514 has an orientation of 135 degrees. Stokes parameters S₀, S₁, and S₂ can be calculated from the intensity measured by the pixels that receive incident light through example polarized pixel arrangement 510 and the Stokes parameters may be used in the AOLP and DOLP calculations. Notably, Stokes parameter S₃ is not calculated using polarized pixel arrangement 510 and therefore, a camera implementing this pixel arrangement is not considered capable of full Stokes imaging and rather may be referred to as partial Stokes imaging.

FIG. 5B illustrates an example polarized pixel arrangement 520 that may be overlaid over portions of polarization camera 250, in accordance with aspects of the disclosure. Polarized pixel arrangement 520 includes four elliptical polarizers 521, 522, 523, and 524. The four elliptical polarizers are linearly independent. Stokes parameters S₀, S₁, S₂, and S₃ can be calculated from the intensity measured by the pixels that receive incident light through example polarized pixel arrangement 520 and the Stokes parameters may be used in the AOLP and DOLP calculations. Notably, Stokes parameter S₃ can be calculated using polarized pixel arrangement 520 and therefore, a camera implementing this pixel arrangement may be considered capable of full Stokes imaging.

FIG. 5C illustrates an example polarized pixel arrangement 530 that may be overlaid over portions of polarization camera 250, in accordance with aspects of the disclosure. Polarized pixel arrangement 530 includes four linear polarizers (511, 512, 513, and 514) a right-hand circular (RHC) polarizer 535, and a left-hand circular (LHC) polarizer 536. Stokes parameters S₀, S₁, S₂, and S₃ can be calculated from the intensity measured by the pixels that receive incident light through example polarized pixel arrangement 530 and the Stokes parameters may be used in the AOLP and DOLP calculations. Notably, Stokes parameter S₃ can be calculated using polarized pixel arrangement 530 and therefore, a camera implementing this pixel arrangement may be considered capable of full Stokes imaging. Any of the pixel arrangements in FIGS. 5A-5C may be included in filter layer 253, for example.

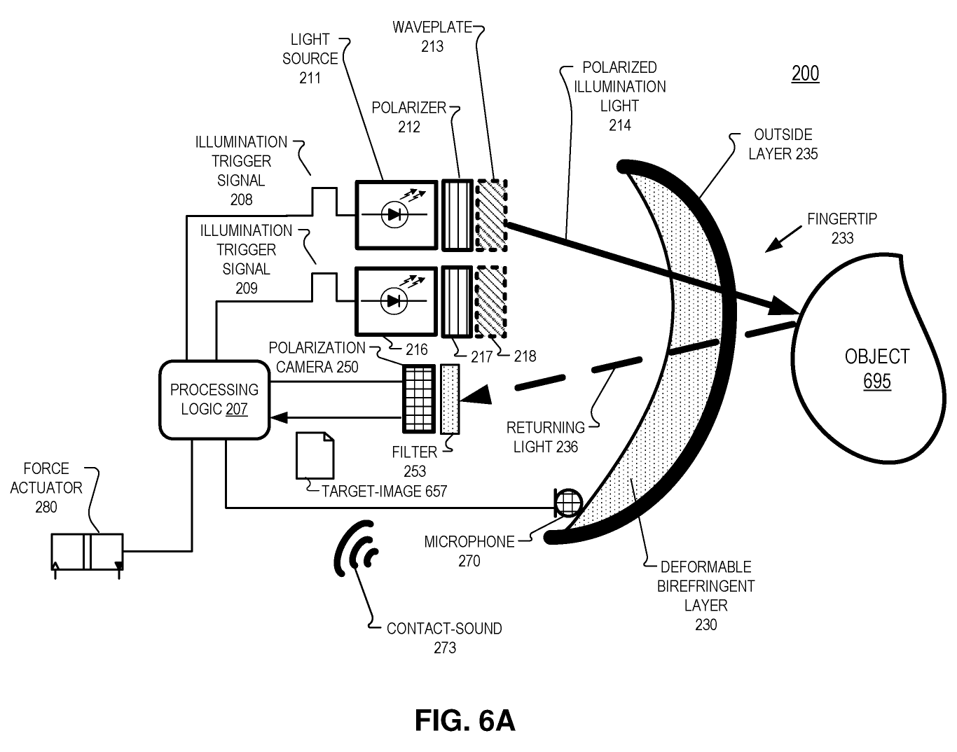

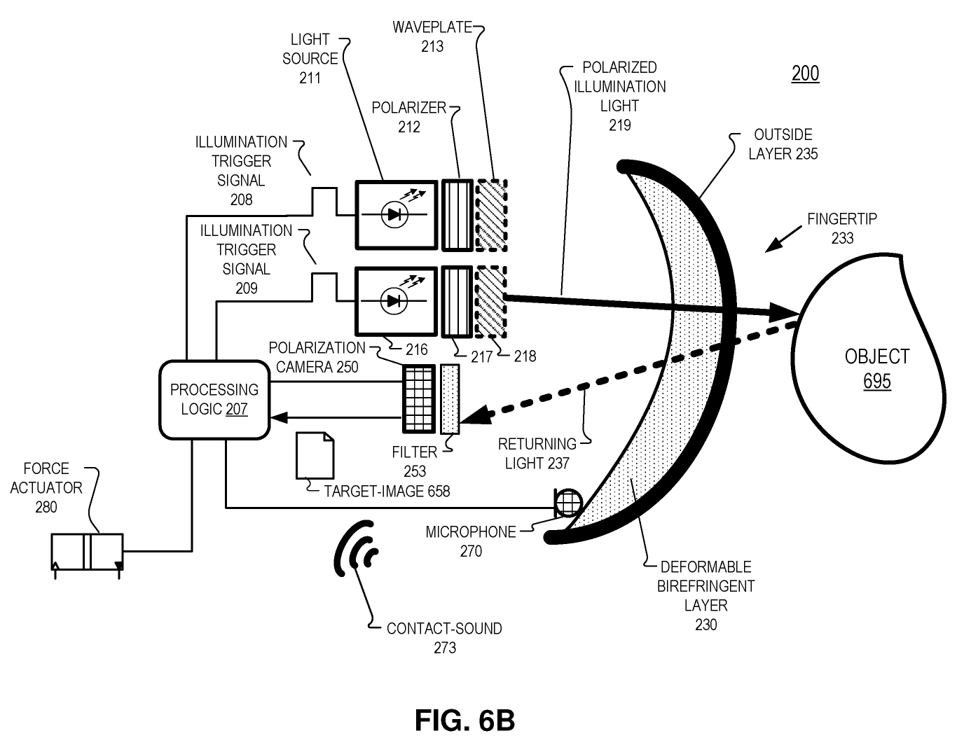

FIGS. 6A and 6B illustrate the optical path for capturing target-image(s) of an object 695 outside fingertip 233, in accordance with aspects of the disclosure. Polarization camera 250 may be configured to capture force-images to determine the force exerted by fingertip 233 and also be utilized as a computer vision (CV) camera to capture target-images of objects in the external environment of a robot. Providing on-fingertip imaging may be especially useful when the fingertip 233 enters an area (e.g. a drawer) that is not easily imaged by other cameras on the robot. Polarization camera 250 is configured to capture the target-image through the deformable birefringent layer 230.

In FIG. 6A, polarized illumination light 214 is emitted in response to processing logic 207 driving illumination trigger signal 208 onto light source 211. While a portion of polarized illumination light 214 is reflected/scattered back to polarization camera 250, a portion of polarized illumination light 214 propagates through layer 230 (and through outside layer 235 if installed) and encounters object 695. Object 695 reflects/scatters the transmitted portion of polarized illumination light 214 back through layer 230 (and through outside layer 235 if installed) as returning light 236 to become incident on polarization camera 250 through filter layer 253. Returning light 236 has the same wavelength as polarized illumination light 214. Polarization camera 250 captures a target-image 657 of object 695 by imaging returning light 236. Target-image 657 may be captured prior to fingertip 233 contacting object 695.

In FIG. 6B, polarized illumination light 219 is emitted in response to processing logic 207 driving illumination trigger signal 209 onto light source 216. While a portion of polarized illumination light 219 is reflected/scattered back to polarization camera 250, a portion of polarized illumination light 219 propagates through layer 230 (and through outside layer 235 if installed) and encounters object 695. Object 695 reflects/scatters the transmitted portion of polarized illumination light 219 back through layer 230 (and through outside layer 235 if installed) as returning light 237 to become incident on polarization camera 250 through filter layer 253. Returning light 237 has the same wavelength as polarized illumination light 219. Polarization camera 250 captures a target-image 658 of object 695 by imaging returning light 237. Target-image 658 may be captured prior to fingertip 233 contacting object 695.

Target-image 657 and 658 may be captured by time-multiplexing the illumination of the light sources 211 and 216 in concert with the polarization camera capturing images 657 and 658. In some implementations, a surface roughness of target/object 695 may be classified based on the first target-image 657 and second target-image 658. Classifying the surface roughness of the target/object 695 may include (1) analyzing an intensity value of at least one of the first target-image 657 and the second target-image 658; and (2) analyzing a Degree of Linear Polarization (DOLP) of at least one of the first target-image 657 and the second target-image 658. Intensity values are generated by averaging the intensity of four sub-pixels of polarization camera 250 where each sub-pixel is overlaid with a different polarization filter, in some implementations. The material type (e.g. glass, metal, diffuse object) of the target/object 695 may also be classified based on the first target-image 657 and second target-image 658. Classifying the material type of the target/object 695 may include (1) analyzing an intensity value of at least one of the first target-image 657 and the second target-image 658; and (2) analyzing a Degree of Linear Polarization (DOLP) of at least one of the first target-image 657 and the second target-image 658. DOLP is lower for diffuse objects because the light is depolarized in the encounter with the diffuse surface so if the DOLP of an image of an object is low, the object is likely diffuse. If DOLP is high, but intensity in the target-image is high, the material is likely metal since metal surface are strong reflectors with (generally) more specular surfaces. If DOLP is high, but intensity in the target-image is low, the material is likely glass or a transparent material. It is advantageous to classify the surface of an object because the required force for the fingertip(s) to interact/hold/move the object may differ based on the surface of the object.

In implementations of the disclosure, processing logic 207 is configured to receive a force-image (e.g. force-image 257 and/or 258) and a target-image (e.g. target-image 657 and/or 658) from the polarization camera 250. Processing logic 207 may be configured to drive the actuator 280 based on at least one force-image and at least one target-image. The target-image of the object 695 may be captured prior to the force-image.

In some implementations, the polarization camera may image object 695 without illumination from light sources 211 nor 216. In this implementation, polarization camera 250 is configured to capture the target-image of the object 695 while the illumination source(s) are not emitting polarized illumination light.

The term “processing logic” in this disclosure may include one or more processors, microprocessors, multi-core processors, Application-specific integrated circuits (ASIC), and/or Field Programmable Gate Arrays (FPGAs) to execute operations disclosed herein. In some implementations, a low-power near-sensor compute System on Chip (SoC) is utilized and disposed proximate to the polarization camera 250 for low-latency sensing pipelines. The low-power SoC may directly control the polarization camera 250. The low-power SoC may include an integrated Artificial Intelligence (AI) accelerator. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Networks may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A robotic fingertip comprising:
a polarization camera;
a deformable birefringent layer configured to interact with objects; and
an illumination source configured to emit polarized illumination light toward the deformable birefringent layer, wherein the polarization camera is configured to selectively capture a force-image of returning light having a specific polarization orientation, the polarized illumination light being reoriented by the deformable birefringent layer as the returning light having the specific polarization orientation.

2. The robotic fingertip of claim 1 further comprising:
processing logic configured to receive the force-image from the polarization camera; and
an actuator to mobilize the robotic fingertip, wherein the processing logic is configured to drive the actuator based on analyzing the force-image for force-patterns in the force-image.

3. The robotic fingertip of claim 2, wherein the analyzing the force-patterns in the force-image includes analyzing for shear force of the deformable birefringent layer, the shear force being defined as approximately orthogonal to an optical axis of the polarization camera.

4. The robotic fingertip of claim 2, wherein the analyzing the force-patterns in the force-image includes analyzing for normal force of the deformable birefringent layer, the normal force direction running approximately along an optical axis of the polarization camera.

5. The robotic fingertip of claim 1, wherein the polarization camera is configured to capture a target-image of an object outside the robotic fingertip, wherein the polarization camera is configured to capture the target-image through the deformable birefringent layer.

6. The robotic fingertip of claim 5 further comprising:
processing logic configured to receive the force-image and the target-image from the polarization camera; and
an actuator to mobilize the robotic fingertip, wherein the processing logic is configured to drive the actuator based on the force-image and the target-image.

7. The robotic fingertip of claim 5, wherein the polarization camera is configured to capture the target-image of the object outside the robotic fingertip while the illumination source is not emitting the polarized illumination light.

8. The robotic fingertip of claim 5 further comprising:
a second illumination source configured to emit second polarized illumination light have a different polarization orientation than the polarized illumination light emitted by the illumination source;
processing logic configured to:
drive the polarization camera to capture the target-image while the
polarized illumination light illuminates the object;
drive the polarization camera to capture a second target-image while the
second polarized illumination light illuminates the object; and
classify a surface roughness or a material type of the object based on the target-image and the second-target image.

9. The robotic fingertip of claim 8, wherein classifying the surface roughness of the target includes analyzing (1) an intensity value; and (2) a Degree of Linear Polarization (DOLP) of at least one of the target-image and the second target-image.

10. The robotic fingertip of claim 1 further comprising:
a microphone configured to record a contact-sound of the robotic fingertip interacting with an object outside the robotic fingertip;
processing logic configured to receive the contact-sound from the microphone and configured to save a pre-touch image captured by the polarization camera immediately prior to the contact-sound being recorded by the microphone; and
generating a force-value by comparing the force-image to the pre-touch image, the force-image captured subsequent to the contact-sound is recorded by the microphone.

11. The robotic fingertip of claim 10, wherein the microphone is in contact with the deformable birefringent layer.

12. The robotic fingertip of claim 1, wherein the polarization camera is configured to provide partial Stokes imaging.

13. The robotic fingertip of claim 1, wherein the polarization camera is configured to provide full Stokes imaging.

14. The robotic fingertip of claim 1, wherein the polarization camera is configured to image four elliptical polarization states.

15. The robotic fingertip of claim 1, wherein the polarization camera is configured to image four linear polarization states.

16. The robotic fingertip of claim 1 further comprising:
an outside layer that is at least partially transparent and at least partially reflective, wherein the deformable birefringent layer is disposed between the polarization camera and the outside layer, and wherein the returning light that is incident on the polarization camera to generate the force-image is reflected by the outside layer.

17. The robotic fingertip of claim 16, wherein the outside layer is a metallic layer.

18. The robotic fingertip of claim 1, wherein the polarized illumination light is elliptically polarized illumination light.

19. The robotic fingertip of claim 1, wherein the illumination source includes a light source, a linear polarizer, and a waveplate.

20. A device comprising:
a polarization camera;
an outside layer that is at least partially transparent;
a deformable birefringent layer configured to interact with objects;
an infrared illumination source configured to emit infrared illumination light toward the deformable birefringent layer, wherein the polarization camera is configured to selectively capture an image of infrared returning light, the infrared illumination light being redirected by the deformable birefringent layer as the infrared returning light;
an actuator configured to modulate a deformation of the deformable birefringent layer; and
processing logic configured to drive the actuator in response to analyzing the image for deformation.
